(19) United States
(12) Patent Application Publication
(10) Pub. No.: US 2008/0028400 A1
(43) Pub. Date: Jan. 31, 2008

(54) Virtualization comprising integration of host and guest user interfaces

(75) Inventors: Martin Taillefer, Redmond, WA (US); Naveen K. Kachroo, Redmond, WA (US); Kenneth L. Crocker, Sammamish, WA (US); Bruno C. Silva, Clyde Hill, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/495,313

(22) Filed: Jul. 27, 2006

(51) Int. Cl. G06F 9/455

(52) U.S. Cl. 718/1

(57) ABSTRACT

A virtualization solution provides a streamlined end-to-end user experience through the integration of the host user interface and the guest user interface, hiding the complexities and incongruities of the underlying virtualization engine. The guest environment is controlled by a graphical user interface of the host system via an initialization menu, which is renderable via the graphical user interface of the host system. Applications of the guest environment can be launched via the initialization menu. Various embodiments are disclosed. For example, pushing a power button on the host system initiates a graceful power shutdown of the guest environment; when a disc is inserted into the host system, options are provided via the guest environment, for operating on the disc; the real-time clock of the host system is controlled by the guest environment; the host system is queried for display settings, and the guest environment uses the display setting if compatible.

### TECHNICAL FIELD

The technical field generally relates to computer processing and more specifically relates to virtualization.

### BACKGROUND

Game consoles and other fixed-function devices such as set-top boxes, cellular phones, portable entertainment devices, and many consumer electronics devices, generally are designed to perform a limited set of well-defined functions. Attempts have been made to virtualize capabilities on a fixed-function device. Virtualization enables a guest environment to execute on a host computing environment, thereby expanding the number of applications that can be executed on the host computing environment. In an operating system virtualization environment for example, a host computing device includes a host operating system that runs directly on the physical hardware of the host device. To achieve operating system virtualization, the host operating system can execute an emulator program that creates a guest environment sufficient to run a guest operating system.

Traditional virtualization solutions maintain independent guest and host environments creating a “sandbox” in which the guest environment is isolated from the host environment. This sandbox technique insulates the underpinnings of the emulated environment from the rest of the host environment. This sandbox technique also segregates the guest user interface such that it is contained and independent from the host's own user interface. Thus, a user of such a virtualization system is acutely aware of the boundary between the host and guest, and typically must explicitly choose to interact with one or the other.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

In a virtualization system, the user interface of a host device, such as a game device for example (e.g., MICROSOFT® Xbox) is tightly integrated with a guest environment, such as a MICROSOFT® Windows operating system for example, providing a user experience that blurs the boundaries between host environment and the guest environment. Features of the guest environment are integrated with the host environment such that the complexities and incongruities of the underlying virtualization engine are hidden, providing a seamless, natural experience for end-users.

A general model is described that tightly couples a guest user interface and a host user interface in order to create the illusion of a single unified system. By hiding the inherent complexities, subtleties, and incongruities of the underlying virtualization technology, the end-user is provided with a more natural and productive interaction.

In an example configuration, the guest environment is controlled and influenced by a graphical user interface of the host system via an initialization menu, such as a start menu or the like. The initialization menu is renderable via a graphical user interface of the host system. Applications of the guest environment (e.g., MICROSOFT® OFFICE applications), can be launched via the initialization menu. In an example embodiment, the guest environment comprises a start menu, or the like, such as a MICROSOFT® WINDOWS start menu for example, and the initialization menu within the host user interface is automatically updated to reflect changes in the guest user interface's start menu.

In various configurations, the guest environment is controlled via a hardware user interface of the host system. For example, pushing a power button on the host system will initiate a controlled, graceful power shutdown of the guest environment before performing a physical shutdown of the host. In another example, when a disc, or other type of storage device (e.g., flash memory device), is inserted into the host system, prompts are provided via the guest environment, indicating that a disc has been inserted, and optionally, providing options pertaining to the disc insertion.

In an example embodiment, upon launch of the guest environment, the host system is queried for information which is utilized by the guest environment. For example, when starting, the guest environment queries the host system for information pertaining to the current display settings and appropriately configures the display settings of the guest environment. In another example embodiment, the guest environment controls the real-time clock of the host system, such that setting the time in the guest environment affects the clock of the host.

### BRIEF DESCRIPTION OF THE DRAWINGS

The foregoing summary, as well as the following detailed description, is better understood when read in conjunction with the appended drawings.

FIG. 1 is an illustration of an example initialization menu.

FIG. 2 is a flow diagram of an example process for accomplishing virtualization comprising integration of the host and guest user interfaces.

FIG. 3 is a block diagram of an example game console in which virtualization comprising integration of the host and guest user interfaces can be accomplished.

FIG. 4 is an illustration of an example computing environment for accomplishing virtualization comprising integration of the host and guest user interfaces.

### DETAILED DESCRIPTION OF ILLUSTRATIVE EMBODIMENTS

As described herein, a virtualization system makes it possible to run a general-purpose operating system, such as the MICROSOFT® WINDOWS operating system, and applications that run under the MICROSOFT® WINDOWS operating system, on a fixed-function device such as a game console, such that the host system and the guest environment are tightly integrated so as to blur the boundaries therebetween. A game console is described as an example embodiment of the host system. It is to be understood, however, that other fixed-function platforms can serve as a host system, such as a set-top box, a portable phone, a portable entertainment device, a personal digital assistant (PDA), or the like, for example. The MICROSOFT® WINDOWS operating system is described as an example embodiment of the guest environment. It is to be understood, however that this embodiment is exemplary, and that other guest environments are applicable.

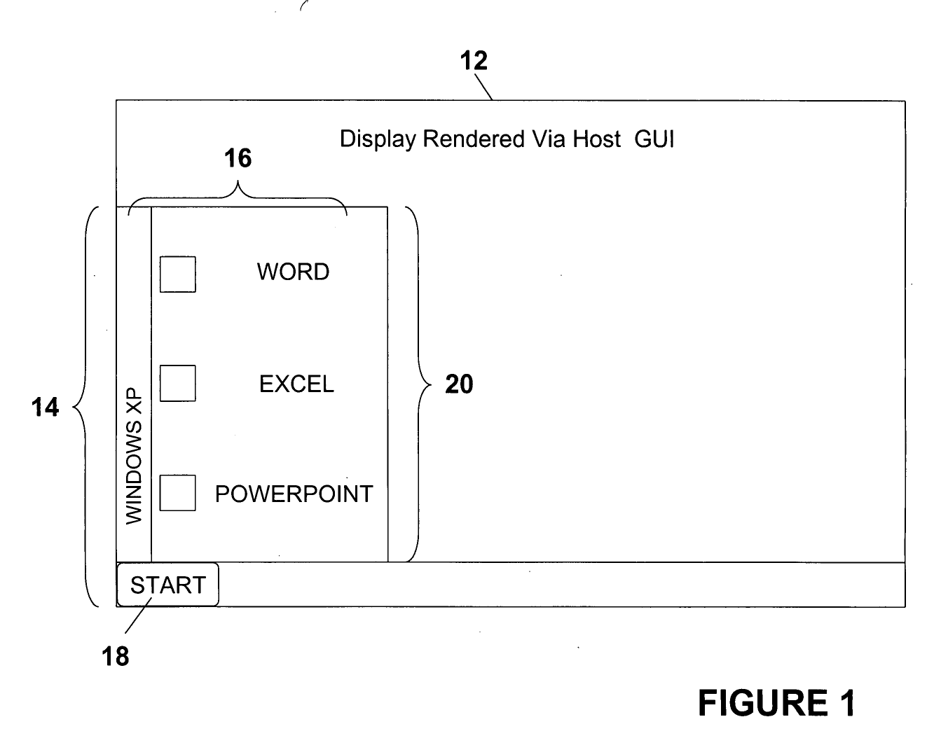

FIG. 1 is an illustration of an example initialization menu 14 rendered on a display device 12. The rendering depicted in FIG. 1 is provided by a graphical user interface (GUI) of a host game console (game console not shown). The initialization menu comprises application icons and text 16. As depicted, the initialization menu appears similar to a MICROSOFT® WINDOWS start menu. This depiction, however, is exemplary, and the initialization menu 14 can have any appropriate appearance. The guest environment, as depicted in FIG. 1, is MICROSOFT® WINDOWS XP.

The operating system and applications in the guest environment can be launched from the initialization menu 14. Launching the guest environment virtualizes an operating system(s) not provided by the host system. The initialization menu 14 is indicative of the operating system and applications that are available via the guest environment. Applications depicted in the application portion 20 of the initialization menu 14 include MICROSOFT® Word, Excel, and PowerPoint. A user can select one or more applications in the guest environment from the application portion 20 of the initialization menu 14. The user can navigate the application portion 20 to launch various applications not provided by the host system. In an example embodiment, in which the host system comprises a game system, the game controller of the game system can be used to navigate, select, and launch applications. In an example embodiment, in which the game system comprises a MICROSOFT® XBOX game system, the start graphic 18 of the initialization menu 14 is rendered on a display device (e.g., monitor, television, or the like) of the game system. The user can use the XBOX gamepad to select the start graphic 18 to render (e.g., have pop up) the application portion 20 of the initialization menu 14. The user can select, using the gamepad, an application from the application portion 20. The selected application will be launched (instantiated and started).

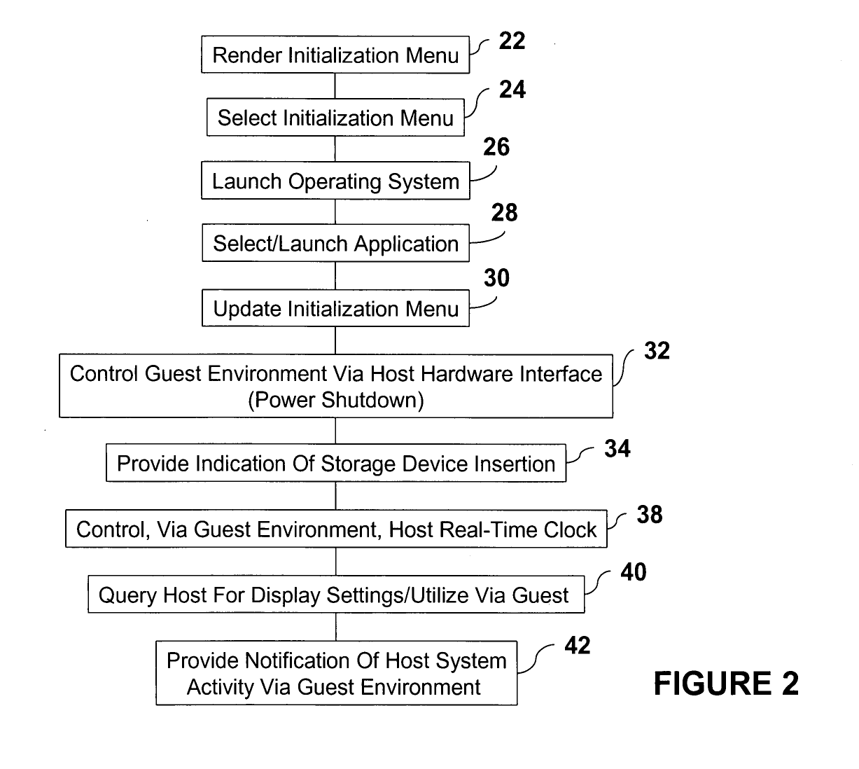

FIG. 2 is a flow diagram of an example process for accomplishing virtualization comprising integration of the host and guest user interfaces. The example process depicted in FIG. 2 is described in the context of the host system comprising a fixed-function device game system, such as a MICROSOFT® XBOX game system, and the guest environment comprising a MICROSOFT® WINDOWS operating system. An initialization menu is rendered at step 22. The initialization menu is rendered via the graphical user interface of the host system. For example, in a host system comprising a MICROSOFT® XBOX game system, the initialization menu is rendered on the display device being utilized by the MICROSOFT® XBOX game system via the MICROSOFT® XBOX game system graphical user interface.

In this example, a graphic (e.g., the start graphic 18 of FIG. 1) could be rendered on a toolbar of the display while the user is interacting with the MICROSOFT® XBOX game system. The initialization menu is selected at step 24. This can be accomplished, for example, by selecting the graphic (e.g., start graphic) to have the available applications indicated (e.g., list of applications pop up such as depicted in application portion 20 in FIG. 1). The operating system of the guest environment is launched at step 26. In an example embodiment, the operating system automatically is launched via selection of the initialization menu (step 24). An application is selected and launched at step 28. This can be accomplished by selecting an application of interest from the initialization menu. Launching an application comprises instantiating the application for execution.

In an example embodiment, an application automatically can be launched at step 24 via selection of the initialization menu. For example, if the initialization menu is indicative of a single application, such as MICROSOFT® WORD for example, the application can be automatically launched when the initialization menu is selected (step 24). That is, selection of the initialization menu (step 24) would automatically launch the guest operating system (step 26) and subsequently automatically launch the guest application (step 28).

At step 30, in an example scenario, the guest environment, MICROSOFT® WINDOWS, comprises a start menu indicating the applications, capable of being launched (launchable) within the guest environment, and the initialization menu is automatically updated to reflect the state of the start menu. For example, as applications are added to the guest environment, the start menu will reflect the new applications. In accordance with this example embodiment, the initialization menu also will be automatically updated to be indicative of the new applications. Thus, the initialization menu is indicative of the state of the guest start menu.

In another example embodiment, the initialization menu provides an indication of the usage of the guest applications. For example, the host system can track the usage of applications in the guest environment, and render the initialization menu so as to indicate this usage. For example, the guest environment applications can be rendered, on the initialization menu, in a list indicating the most recently used applications, such as most recently used application at the top of the list. Thus, a user can control the behavior of the guest environment from within the host user interface and the host user interface will automatically adapt to changes in the stat of the guest environment.

In an example embodiment, the guest environment is controlled via a hardware user interface of the host system at step 32. For example, activating (e.g., pushing) a power on/off switch on the host system will initiate a controlled, graceful power shutdown of the guest environment followed by a graceful shutdown of the host itself. A controlled, graceful power shutdown comprises properly closing all open applications in the guest environment and properly closing the operating system in the guest environment. In the example configuration in which the host system comprises a MICROSOFT® XBOX game system and the guest environment comprises a MICROSOFT® WINDOWS operating system, pressing the MICROSOFT® XBOX game system power button will gracefully shut down the MICROSOFT® WINDOWS operating system and any applications therein and then shutdown the MICROSOFT® XBOX game system itself.

At step 34, in an example embodiment, when a disc, or other type of storage device (e.g., flash memory device, floppy, or the like), is inserted into the host system, prompts are provided via the guest environment, indicating that a disc has been inserted, and optionally, providing options pertaining to the disc insertion. For example, in the example configuration in which the host system comprises a MICROSOFT® XBOX game system and the guest environment comprises a MICROSOFT® WINDOWS operating system, when a disc is inserted into the MICROSOFT® XBOX disc drive, the insertion event is forwarded to the guest environment, i.e., the MICROSOFT® WINDOWS operating system. The MICROSOFT® WINDOWS operating system performs its disc insertion protocol as if media had been inserted while the MICROSOFT® WINDOWS operating system was executing. An indication is provided, via the MICROSOFT® WINDOWS operating system that a storage device has been inserted. For example, when a user inserts a DVD movie into the MICROSOFT® XBOX disc drive, a pop up indication is provided, via the MICROSOFT® WINDOWS operating system, offering the user a choice between using the MICROSOFT® XBOX DVD player or the default MICROSOFT® WINDOWS DVD player.

In an example embodiment, at step 38, the guest environment is in control of the host system real-time clock. For example, when the guest environment is launched, it samples the host system for the current time. As changes are made to the guest environment real-time clock (e.g., via the user and/or automatically), the changes to the guest environment real-time clock are applied to the host system real-time clock. This helps to ensure that the guest environment and the host system have the same notion of current time. In the example configuration in which the host system comprises a MICROSOFT® XBOX game system and the guest environment comprises a MICROSOFT® WINDOWS operating system, when the MICROSOFT® WINDOWS operating system is launched, it samples the MICROSOFT® XBOX game system for the current time. As changes are made to the real-time clock in MICROSOFT® WINDOWS, the real-time clock in the MICROSOFT® XBOX game system is updated accordingly.

At step 40, in another example embodiment, the host system is queried for information pertaining to the current display setting, such as resolution for example, and appropriately configures the display settings of the guest environment. When virtualization is initialized, the host system is queried for its current display resolution. This information is utilized to configure the guest environment for virtualization. The display setting information is analyzed for compatibility with the guest environment. If the display settings are compatible with the guest environment, the display settings are utilized in the guest environment. If the display settings are not compatible with the guest environment, an indication of the incompatibility is provided, allowing a user to resolve the incompatibility.

At step 42, notification of activity in the host is provided via the guest environment. In the example configuration in which the host system comprises a MICROSOFT® XBOX game system, notifications such as notifications originating with MICROSOFT® XBOX Live service are redirected to and rendered via the guest environment. The notifications can be formatted to be compatible with the guest environment. For example, in the example configuration in which the guest environment comprises a MICROSOFT® WINDOWS operating system, notifications can be rendered via MICROSOFT® WINDOWS compatible dialog boxes and pop ups rather than MICROSOFT® XBOX game system pop ups.

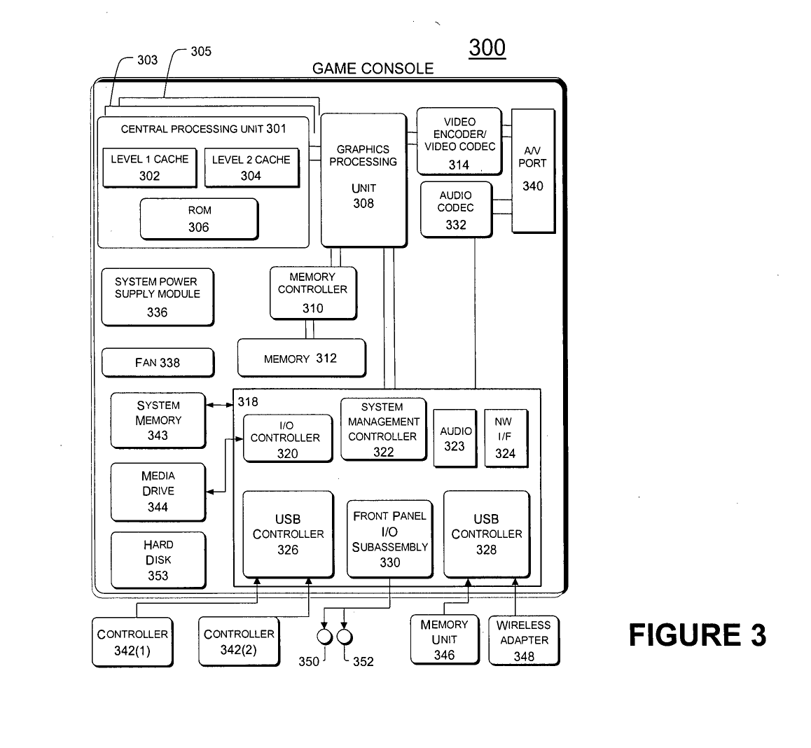

FIG. 3 is a block diagram of an example game console 300 in which virtualization comprising integration of the host and guest user interfaces can be accomplished. The game console 300 along with other devices described herein, such as a display device, are capable of performing the functions needed to accomplish virtualization comprising integration of the host and guest user interfaces, as describe above. Game console 300 is an example of a fixed-function host system, although, as noted above, a game console is only one example of a fixed-function host device. A typical game console, like most fixed-function devices, comprises hardware and software that are specifically designed to support a core set of usage scenarios. Via virtualization, software that virtualizes sufficient features of the guest environment makes it possible to run the guest environment on the host system. In an example embodiment, in which the host device is a game console, the software that enables the use of the guest environment can be marketed as an ordinary title for that game console.

Game console 300 has a central processing unit (CPU) 301 having a level 1 (L1) cache 302, a level 2 (L2) cache 304, and a flash ROM (Read-only Memory) 306. The level 1 cache 302 and level 2 cache 304 temporarily store data and hence reduce the number of memory access cycles, thereby improving processing speed and throughput. The flash ROM 306 can store executable code that is loaded during an initial phase of a boot process when the game console 300 is initially powered. Alternatively, the executable code that is loaded during the initial boot phase can be stored in a FLASH memory device (not shown). Further, ROM 306 can be located separate from CPU 301. Game console 300 can, optionally, be a multi-processor system; for example game console 300 can have three processors 301, 303, and 305, where processors 303 and 305 have similar or identical components to processor 301.

A graphics processing unit (GPU) 308 and a video encoder/video codec (coder/decoder) 314 form a video processing pipeline for high speed and high resolution graphics processing. Data is carried from the graphics processing unit 308 to the video encoder/video codec 314 via a bus. The video processing pipeline outputs data to an A/V (audio/video) port 340 for transmission to a television or other display device. A memory controller 310 is connected to the GPU 308 and CPU 301 to facilitate processor access to various types of memory 312, such as, but not limited to, a RAM (Random Access Memory).

Game console 300 includes an I/O controller 320, a system management controller 322, an audio processing unit 323, a network interface controller 324, a first USB host controller 326, a second USB controller 328 and a front panel I/O subassembly 330 that may be implemented on a module 318. The USB controllers 326 and 328 serve as hosts for peripheral controllers 342(1)-842(2), a wireless adapter 348, and an external memory unit 346 (e.g., flash memory, external CD/DVD ROM drive, removable media, etc.). The network interface 324 and/or wireless adapter 348 provide access to a network (e.g., the Internet, home network, etc.) and may be any of a wide variety of various wired or wireless interface components including an Ethernet card, a modem, a Bluetooth module, a cable modem, and the like.

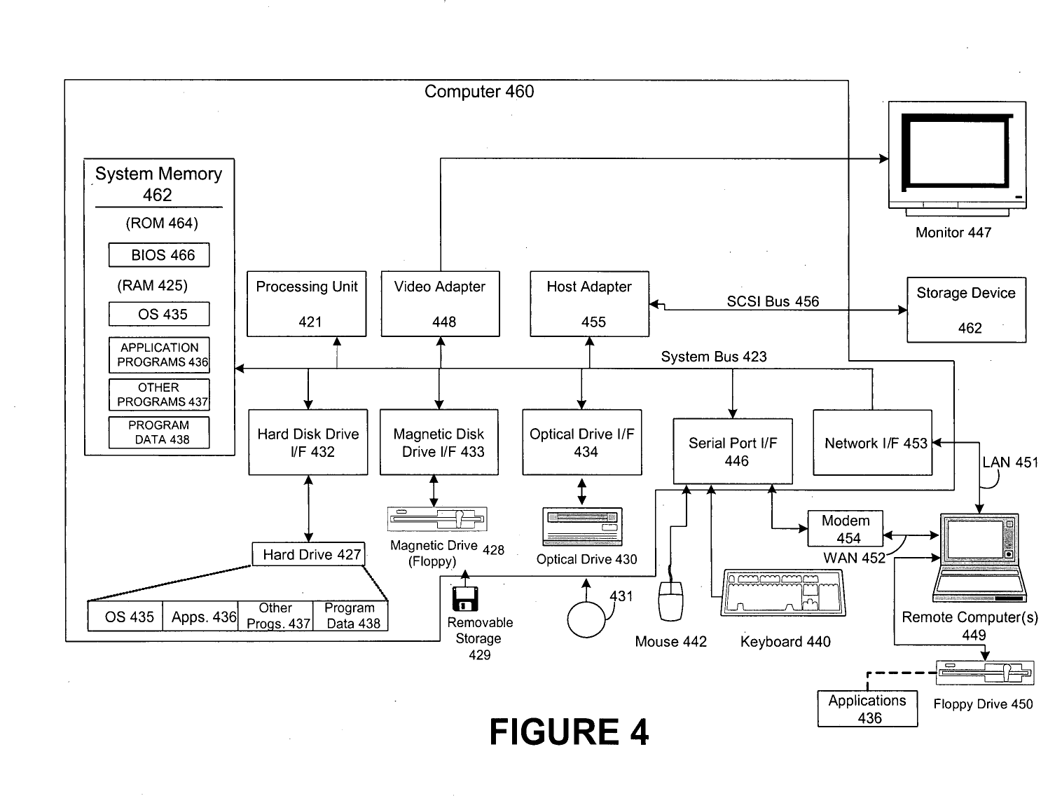

System memory 343 is provided to store application data that is loaded during the boot process. A media drive 344 is provided and may comprise a DVD/CD drive, hard drive, or other removable media drive, etc. The media drive 344 may be internal or external to the game console 300. When media drive 344 is a drive or reader for removable media (such as removable optical disks, or flash cartridges), then media drive 344 is an example of an interface onto which (or into which) media are mountable for reading. Application data may be accessed via the media drive 344 for execution, playback, etc. by game console 300. Media drive 344 is connected to the I/O controller 320 via a bus, such as a Serial ATA bus or other high speed connection (e.g., IEEE 3394). While media drive 344 may generally refer to various storage embodiments (e.g., hard disk, removable optical disk drive, etc.), game console 300 may specifically include a hard disk 352, which can be used to store game data, application data, or other types of data, and on which the file systems depicted in FIGS. 3 and 4 may be implemented.

The system management controller 322 provides a variety of service functions related to assuring availability of the game console 300. The audio processing unit 323 and an audio codec 332 form a corresponding audio processing pipeline with high fidelity, 3D, surround, and stereo audio processing according to aspects of the present subject matter described herein. Audio data is carried between the audio processing unit 323 and the audio codec 326 via a communication link. The audio processing pipeline outputs data to the A/V port 340 for reproduction by an external audio player or device having audio capabilities.

The front panel I/O subassembly 330 supports the functionality of the power button 350 and the eject button 352, as well as any LEDs (light emitting diodes) or other indicators exposed on the outer surface of the game console 300. A system power supply module 336 provides power to the components of the game console 300. A fan 338 cools the circuitry within the game console 300.

The CPU 301, GPU 308, memory controller 310, and various other components within the game console 300 are interconnected via one or more buses, including serial and parallel buses, a memory bus, a peripheral bus, and a processor or local bus using any of a variety of bus architectures.

When the game console 300 is powered on or rebooted, application data can be loaded from the system memory 343 into memory 312 and/or caches 302, 304 and executed on the CPU 301. The application can present a graphical user interface that provides a consistent user experience when navigating to different media types available on the game console 300. In operation, applications and/or other media contained within the media drive 344 may be launched or played from the media drive 344 to provide additional functionalities to the game console 300.

The game console 300 may be operated as a standalone system by simply connecting the system to a television or other display. In this standalone mode, the game console 300 may allow one or more users to interact with the system, watch movies, listen to music, and the like. However, with the integration of broadband connectivity made available through the network interface 324 or the wireless adapter 348, the game console 300 may further be operated as a participant in a larger network community.

As described above, virtualization comprising integration of the host and guest user interfaces can be accomplished in a general-purpose computing device. FIG. 4 shows an example computing environment comprising such a computing device 460. Aspects of virtualization comprising integration of the host and guest user interfaces are operational with numerous other general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

As shown in FIG. 4, an exemplary general purpose computing environment includes a computing device 460 or the like, including a processing unit 421, a system memory 462, and a system bus 423 that couples various system components including the system memory to the processing unit 421. The system bus 423 may be any of several types of bus structures including a memory bus or memory controller, a peripheral bus, and a local bus using any of a variety of bus architectures. The system memory includes read only memory (ROM) 464 and random access memory (RAM) 425. A basic input/output system 466 (BIOS), containing basic routines that help to transfer information between elements within the computing device 460, such as during start up, is stored in ROM 464.

The computing device 460 may further include a hard disk drive 427 for reading from and writing to a hard disk (hard disk not shown), a magnetic disk drive 428 (e.g., floppy drive) for reading from or writing to a removable magnetic disk 429 (e.g., floppy disk, removal storage), and an optical disk drive 430 for reading from or writing to a removable optical disk 431 such as a CD ROM or other optical media. The hard disk drive 427, magnetic disk drive 428, and optical disk drive 430 are connected to the system bus 423 by a hard disk drive interface 432, a magnetic disk drive interface 433, and an optical drive interface 434, respectively. The drives and their associated computer readable media provide non volatile storage of computer readable instructions, data structures, program modules and other data for the computing device 460. Although the exemplary environment described herein employs a hard disk, a removable magnetic disk 429, and a removable optical disk 431, it should be appreciated by those skilled in the art that other types of computer readable media which can store data that is accessible by a computer, such as magnetic cassettes, flash memory devices, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 429, optical disk 431, ROM 464, or RAM 425, including an operating system 435, one or more application programs 436, other program modules 437, and program data 438. For example, application programs for performing the functions associated with accomplishing virtualization comprising integration of the host and guest user interfaces, as described herein, can be store in various combinations of the hard disk, the magnetic disk 429, the optical disk 431, the ROM 464, or the RAM 425. A user may enter commands and information into the computing device 460 through input devices such as a keyboard 440 and pointing device 442 (e.g., mouse). Other input devices (not shown) may include a microphone, joystick, game pad, satellite disk, scanner, or the like. These and other input devices are often connected to the processing unit 421 through a serial port interface 446 that is coupled to the system bus, but may be connected by other interfaces, such as a parallel port, game port, or universal serial bus (USB). A monitor 447 or other type of display device is also connected to the system bus 423 via an interface, such as a video adapter 448. In addition to the monitor 447, computing devices typically include other peripheral output devices (not shown), such as speakers and printers. The exemplary system of FIG. 4 also includes a host adapter 455, Small Computer System Interface (SCSI) bus 456, and an external storage device 462 connected to the SCSI bus 456.

The computing device 460 may operate in a networked environment using logical connections to one or more remote computers, such as a remote computer 449. The remote computer 449 may be another computing device (e.g., personal computer), a server, a router, a network PC, a peer device, or other common network node, and typically includes many or all of the elements described above relative to the computing device 460, although only a memory storage device 450 (floppy drive) has been illustrated in FIG. 4. The logical connections depicted in FIG. 4 include a local area network (LAN) 451 and a wide area network (WAN) 452. Such networking environments are commonplace in offices, enterprise wide computer networks, intranets and the Internet.

When used in a LAN networking environment, the computing device 460 is connected to the LAN 451 through a network interface or adapter 453. When used in a WAN networking environment, the computing device 460 can include a modem 454 or other means for establishing communications over the wide area network 452, such as the Internet. The modem 454, which may be internal or external, is connected to the system bus 423 via the serial port interface 446. In a networked environment, program modules depicted relative to the computing device 460, or portions thereof, may be stored in the remote memory storage device. It will be appreciated that the network connections shown are exemplary and other means of establishing a communications link between the computers may be used.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 421, the memory (both ROM 464 and RAM 425), the basic input/output system (BIOS) 466, and various input/output (I/O) devices such as a keyboard 440, a mouse 442, a monitor 447, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users).

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. The purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface, or GUI.

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

While it is envisioned that numerous embodiments of virtualization comprising integration of the host and guest user interfaces are particularly well-suited for computerized systems, nothing in this document is intended to limit virtualization comprising integration of the host and guest user interfaces to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

Although not required, various aspects of virtualization comprising integration of the host and guest user interfaces can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, detecting malicious software via memory analysis can be practiced with other computer system configurations, including hand held devices, multi processor systems, microprocessor based or programmable consumer electronics, network PCs, minicomputers, mainframe computers, and the like. Further, virtualization comprising integration of the host and guest user interfaces also can be practiced in distributed computing environments where tasks are performed by remote processing devices that are linked through a communications network. In a distributed computing environment, program modules can be located in both local and remote memory storage devices.

The various techniques described herein can be implemented in connection with hardware or software or, where appropriate, with a combination of both. Thus, the methods and apparatuses for virtualization comprising integration of the host and guest user interfaces, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for virtualization comprising integration of the host and guest user interfaces.

The program(s) can be implemented in assembly or machine language, if desired. In any case, the language can be a compiled or interpreted language, and combined with hardware implementations. The methods and apparatuses for virtualization comprising integration of the host and guest user interfaces also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for virtualization comprising integration of the host and guest user interfaces. When implemented on a general-purpose processor, the program code combines with the processor to provide a unique apparatus that operates to invoke the functionality of virtualization comprising integration of the host and guest user interfaces. Additionally, any storage techniques used in connection with virtualization comprising integration of the host and guest user interfaces can invariably be a combination of hardware and software.

While virtualization comprising integration of the host and guest user interfaces has been described in connection with the example embodiments of the various figures, it is to be understood that other similar embodiments can be used or modifications and additions can be made to the described embodiments for performing the same functions for virtualization comprising integration of the host and guest user interfaces without deviating therefrom. Therefore, virtualization comprising integration of the host and guest user interfaces as described herein should not be limited to any single embodiment, but rather should be construed in breadth and scope in accordance with the appended claims.

What is claimed:

1. A method of virtualizing a guest environment in a host system, the method comprising:
rendering, via a graphical user interface of the host system, an initialization menu for launching the guest environment, wherein:
the host system comprises a fixed-function device; and
launching the guest environment virtualizes at least one operating system not provided by the host system.

2. A method in accordance with claim 1, wherein the initialization menu comprises a list of at least one application capable of being launched and not provided by the host system.

3. A method in accordance with claim 2, wherein the host system comprises a game system.

4. A method in accordance with claim 3, further comprising navigating, via a game controller of the game system, the initialization menu to select at least one of the at least one application.

5. A method in accordance with claim 1, wherein the guest environment comprises a start menu indicative of at least one launchable application within the guest environment, the method further comprising updating the initialization menu to reflect a state of the start menu.

6. A method in accordance with claim 1, further comprising controlling the guest environment via a hardware user interface of the host system.

7. A method in accordance with claim 6, further comprising initiating, via actuation of a power on/off switch of the host system, a controlled power shutdown of the guest environment.

8. A method in accordance with claim 1, further comprising, subsequent insertion of a storage device in the host system, providing, via the guest environment, a prompt indicative of the insertion.

9. A method in accordance with claim 8, further comprising providing, via the guest environment, an option to operate on the inserted storage device via one of:
an application within the guest environment; and
an application within the host system.

10. A method in accordance with claim 1, further comprising controlling, via the guest environment, a real-time clock of the host system.

11. A method in accordance with claim 1, further comprising providing, via the guest environment, an indication of host system activity, wherein the indication of host system activity is provide in a format compatible with the guest environment.

12. A method in accordance with claim 1, further comprising:
querying the host system for information pertaining to a display setting utilized by the host system;
determining if the display setting utilized by the host system is compatible with the guest environment; and
if the display setting utilized in the host system is compatible with the guest environment, utilizing, by the guest environment, the display setting.

13. A system for virtualizing a guest environment in a host device, the system comprising:
the host device for providing to a display device, via a graphical user interface, an initialization menu for launching the guest environment; and
the display device for rendering the initialization menu, wherein:
the host device comprises a fixed-function device; and
launching the guest environment virtualizes at least one operating system not provided by the host device.

14. A system in accordance with claim 13, wherein the initialization menu comprises a list of at least one application capable of being launched and not provided by the host device, the display device further for rendering the list.

15. A system in accordance with claim 14, wherein:
the host device comprises a game console; and
the system further comprises a game controller for navigating the initialization menu to select at least one of the at least one application.

16. A system in accordance with claim 13, wherein:
the guest environment comprises a start menu indicative of at least one launchable application within the guest environment;
the start menu is renderable by the display device; and
the initialization menu is updated to reflect a state of the start menu.

17. A system in accordance with claim 13, wherein:
the host device comprises a power on/off switch;
actuation of the power on/off switch initiates a controlled power shutdown of the guest environment;
the host device comprises a real-time clock; and
the guest environment is capable of controlling the real-time clock.

18. A system in accordance with claim 13, wherein:
the host device is capable of receiving a storage device; and
subsequent insertion of a storage device into the host device, the display device is capable of rendering, via the guest environment:
a prompt indicative of the insertion; and
an option to operate on the inserted storage device via one of:
an application within the guest environment; and
an application within the host system.

19. A system in accordance with claim 13, wherein:
the guest environment is capable of rendering, via the display device, an indication of host device activity; and
the indication of host device activity is rendered in a format compatible with the guest environment.

20. A system in accordance with claim 13, wherein:
the host device is queried for information pertaining to a display device setting utilized by the host device;
it is determined if the display device setting utilized by the host device is compatible with the guest environment; and
if the display device setting utilized in the host device is compatible with the guest environment, the guest environment is capable of utilizing the display device setting for rendering via the display device.
